(19) United States
(12) Patent Application Publication
(10) Pub. No.: US 2017/0352004 A1
(43) Pub. Date: Dec. 7, 2017

(54) SYSTEMS, DEVICES, AND METHODS FOR DYNAMICALLY GENERATING DELIVERY DESTINATIONS, TIMES AND ROUTES

(71) Applicant: Wal-Mart Stores, Inc., Bentonville, AR (US)

(72) Inventors: Brian Gerard McHale, Oldham (GB); Pablo Rafael Garro Portilla, Bentonville, AR (US); Parvez Yunusbhai Musani, Bentonville, AR (US); Matthew Allen Jones, Bentonville, AR (US); Donald High, Noel, MO (US); Todd Davenport Mattingly, Bentonville, AR (US)

(21) Appl. No.: 15/609,863

(22) Filed: May 31, 2017

Related U.S. Application Data
(60) Provisional application No. 62/344,118, filed on Jun. 1, 2016.

(51) Int. Cl. G06Q 10/08; G01C 21/36; G01C 21/34

(52) U.S. Cl. CPC G06Q 10/08355; G06Q 10/0833; G01C 21/3415; G01C 21/3617

(57) ABSTRACT

Methodologies, systems, and computer-readable media are provided for generating routes for relocating delivery of objects. Public data relating to a user's current location, a current location of an object to be delivered, and the user's future travel plans is retrieved. Personal data is also retrieved, including customizable relocation preferences and future travel plans associated with the user. A relocation destination is computed for relocating delivery of the object to the user from a current delivery destination to the relocation destination based on the public data and the personal data associated with the user. A relocation time and a relocation route are also computed, based in part on the public data and the personal data associated with the user. A notification of the relocation destination and the relocation time is then transmitted to an electronic device associated with the user.

### RELATED APPLICATIONS

This application claims priority to U.S. Provisional Patent Application Ser. No. 62/344,118 entitled “SYSTEMS, DEVICES, AND METHODS FOR DYNAMICALLY GENERATING DELIVERY DESTINATIONS, TIMES AND ROUTES,” filed on Jun. 1, 2016, the contents of which is hereby incorporated by reference in its entirety.

### BACKGROUND OF THE TECHNOLOGY

Physical objects can scheduled for delivery to individuals using various delivery techniques. In some instances, a user can specify a delivery time and/or a delivery location for the objects being delivered.

### SUMMARY

Embodiments of the present invention utilize a mixture of publicly available data and personal data associated with a user to dynamically compute or re-compute delivery details for delivering objects to a user. For example, embodiments may calculate or re-calculate delivery conditions such as delivery destinations, times and routes based on a mixture of public data retrieved from a user's social media presence and personal data the user has chosen to share with the entity delivering the objects. With this combined pool of information, deliveries of objects may be tailored based on changing conditions.

In accordance with embodiments of the present disclosure, a system for dynamically generating routes for relocating delivery of objects is disclosed. The system includes a database for holding personal data associated with, and provided by, a user. The system also includes a computing device equipped with a processor and in communication with the database and an electronic device associated with the user. The processor is configured to execute a public data extraction module configured to retrieve public data relating to the user's current location, a current location of an object to be delivered, and the user's future travel plans. The processor is also configured to execute a profile module configured to retrieve personal data associated with the user from the database. The personal data includes customizable relocation preferences or future travel plans of the user. The processor is also configured to execute a delivery analysis module configured to compute a relocation destination for relocating delivery of the object to be delivered to the user from a current delivery destination to the relocation destination. The relocation destination is computed, at least in part, based on the public data and the personal data associated with the user. The delivery analysis module is also configured to compute a relocation time based at least in part on the public data and the personal data associated with the user. The delivery analysis module is also configured to compute a relocation route for relocating the delivery of the object to the user at the relocation destination at the relocation time. The relocation route is based at least in part on the public data and the personal data associated with the user. The processor is also configured to execute a notification module configured to transmit an indication of the relocation destination and the relocation time to the electronic device associated with the user.

In some embodiments, the public data is gathered by the public data extraction module from one or more social media accounts associated with the user. The public data can include user preferences, geographic location information, or information relating to planned future activities. In some embodiments, the user's future travel plans include at least one of the user's travel itinerary, regular travel patterns, and planned future activities. In some embodiments, the notification module is also configured to transmit contact information for requesting goods or services related to the object being relocated for delivery to the electronic device associated with the user. In some embodiments, the notification module is also configured to generate a suggestion of a suggested object to be delivered to the user, the suggestion based at least in part on the personal data associated with the user. In some embodiments, the notification module is also configured to transmit a status update to the electronic device associated with the user to update the user on a real time status of the object during the relocated delivery. In some embodiments, the public data extraction module is also configured to retrieve public information relating to weather at a current location of the user or weather at the relocation destination. In some embodiments, the delivery analysis module uses the information relating to weather to compute at least one of the relocation destination, relocation time and relocation route. In some embodiments, the delivery analysis module and the notification module use the information relating to weather to suggest delivery of a new object to the user.

In accordance with alternative embodiments of the present disclosure, a system for dynamically generating routes for delivery of objects is disclosed. The system includes a database holding personal data associated with, and provided by, a user. The system also includes a computing device equipped with a processor and in communication with the database and an electronic device associated with the user. The processor is configured to execute a public data extraction module configured to retrieve public data relating to the user's current location, a current location of an object to be delivered, or the user's future travel plans. The processor is also configured to execute a profile module configured to retrieve personal data associated with the user from the database. The personal data includes customizable delivery preferences or future travel plans of the user. The processor is also configured to execute a delivery analysis module configured to compute a delivery destination for delivery of the object to be delivered to the user. The delivery destination is based, at least in part, on the public data or the personal data associated with the user. The delivery analysis module is also configured to compute a delivery time based at least in part on the public data and the personal data associated with the user. The delivery analysis module is also configured to compute a delivery route for delivery of the object to the user at the delivery destination at the delivery time. The delivery route is based, at least in part, on the public data and the personal data associated with the user. The processor is also configured to execute a notification module configured to transmit an indication of the delivery destination and the delivery time to the electronic device associated with the user.

Additional combinations and/or permutations of the above examples are envisioned as being within the scope of the present disclosure. It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein.

### BRIEF DESCRIPTION OF THE DRAWINGS

The skilled artisan will understand that the drawings primarily are for illustrative purposes and are not intended to limit the scope of the inventive subject matter described herein. The drawings are not necessarily to scale; in some instances, various aspects of the inventive subject matter disclosed herein may be shown exaggerated or enlarged in the drawings to facilitate an understanding of different features. In the drawings, like reference characters generally refer to like features (e.g., functionally similar and/or structurally similar elements).

The foregoing and other features and advantages provided by the present disclosure will be more fully understood from the following description of exemplary embodiments when read together with the accompanying drawings, in which:

FIG. 1 is a flowchart illustrating an exemplary method of generating a route for relocating delivery of objects, according to an embodiment of the present invention.

FIG. 2 is a flowchart illustrating another exemplary method of generating a route for relocating delivery of objects, according to an embodiment of the present invention.

FIG. 3 is a flowchart illustrating another exemplary method of generating a route for relocating delivery of objects, according to an embodiment of the present invention.

FIG. 4 is a flowchart illustrating an exemplary method of generating a route for delivering objects, according to embodiments of the present disclosure.

FIG. 5 is a diagram of an exemplary network environment suitable for a distributed implementation of an exemplary embodiment of the present disclosure.

FIG. 6 is a block diagram of an exemplary computing device that can be used to perform exemplary processes in accordance with an exemplary embodiment of the present disclosure.

### DETAILED DESCRIPTION

Following below are more detailed descriptions of various concepts related to, and embodiments of, inventive methods, apparatus, and systems for generating a route for delivery of objects to a delivery destination and generating a route relocating a previously scheduled delivery of objects from a previous destination to a new destination. It should be appreciated that various concepts introduced above and discussed in greater detail below may be implemented in any of numerous ways, as the disclosed concepts are not limited to any particular manner of implementation. Examples of specific implementations and applications are provided primarily for illustrative purposes.

As used herein, the term “includes” means “includes but is not limited to”, the term “including” means “including but not limited to”. The term “based on” means “based at least in part on”.

In accordance with some embodiments of the present invention, methodologies, systems, apparatus, and non-transitory computer-readable media are described herein to facilitate generating a route for delivery of objects and generating a route for relocating a previously scheduled delivery of objects. In exemplary embodiments, delivery of an object to a user can be improved by delivering the object to a customized location and at a customized time, rather than merely delivering objects to a standard address or P.O. Box. Furthermore, when a user is traveling or changes travel plans unexpectedly, a delivery that is already in progress may need to be relocated to a new delivery location and a new delivery time. In some embodiments, the relocating or recalculating of the delivery location or delivery time can be performed in response to a request by the user, while in other embodiments the recalculating of the delivery location or delivery time can be performed automatically based on an analysis of public and personal data. The recalculation of a delivery location could be achieved, for example, by the system identifying where the customer is going to be using mobile phone GPS data. This then provides an understanding of where the inception point is, of delivery and the customer. Therefore you would get a situation where the customer and the delivery would arrive at the same point. The system would take into account the appropriateness of that delivery point and determine the best delivery point for the customer's arrival. In some embodiments, the user can initiate a recalculation of the delivery location or delivery time by submitting a relocation or recalculation request using a mobile electronic device.

In some embodiments, the system may use various types of public and personal data in order to compute a relocation destination, a relocation time, and/or a relocation route for relocating delivery of an object. The public data can include, for example, data gathered from various social media accounts associated with the user. The personal data can include, but is not limited to, user profile data, data gathered from a global positioning system (GPS), inertial navigation system (INS), and/or other navigation feature of an electronic device associated with the user, etc. The various types of public and personal data can also include, for example, information relating to parking areas, local landmarks and transit terminals, and, etc.

In some example embodiments, the system can use knowledge of the user's typical/historical travel patterns in order to make personal delivery more efficient. For example, the system can aggregate driving or other travel patterns so that items can be positioned along those typical routes, or so that a delivery person can connect with the user along those typical routes in order to complete a delivery. In some embodiments, the user can provide the system with access to travel plans in order to make delivery more efficient. In some embodiments, the system can identify to a delivery person an area where the delivery person can wait nearby the user before final steps are taken for delivery to the user.

In another embodiment, the user may provide travel and luggage information to the system to make unused cargo space available as a space for delivering items. For example, if the user has the option to bring one or two free bags on a flight but is not planning on using all their allotted space, the user can “donate” that cargo space and/or cargo weight allotment for delivery to a person in or near the user's destination location.

In another embodiment, the delivery of objects can be determined, at least in part, based on the weather at the user's location or at a location where the user plans to travel. For example, if an unexpected change in weather occurs, or if the user forgets to bring a weather related object such as an umbrella, the system can automatically initiate delivery of the necessary objects to the user's current or future location.

In another embodiment, the system can provide tracking of the delivery person or provide information relating to the condition of the object being delivered. For example, the user can be provided with a photo or video stream that allows the user to view the condition of the objects that are in transit. The user can also be allowed to sign for or validate the identity or quality of the delivery items remotely and in real time, in some embodiments. The system can also be implemented with the use of a smart locker or smart storage device that can be located on the user's porch, for example, into which delivered objects can be placed after the storage device is unlocked. In some embodiments, the smart storage device can be controlled remotely by the user.

In another embodiment, the system can be implemented using drones as a delivery medium. In such embodiments, the drone could track and identify a user's vehicle and place items at or near the vehicle. In some embodiments, the delivery can be completed even while the vehicle is in motion. In other embodiments, the drone can interface with various smart storage devices associated with the user. Examples of smart storage devices can include a P.O. Box, smart locker, vehicle, or residence.

In another embodiment, the user can designate particular areas (using geofencing technology, for example) where the user does not want delivery to be made. Similarly, the user can also designate particular persons or groups of persons to whom products should not be delivered.

In some example embodiments, the system can provide automatic ordering and/or delivery of objects based on particular situations or delivery scenarios defined by the user. For example, when traveling on vacation, a user with small children can stipulate that the system should deliver diapers and wipes at periodic intervals to a particular location, or that pet food be delivered to a particular location while the user is away. In other embodiments, a consumable “care package,” such as a set of toiletries and a change of clothing, can be set for delivery in the event of a particular travel situation. Another delivery scenario can include an emergency situation, such as a snow storm or power outage. In such an emergency situation, a set of emergency items can be automatically ordered and delivered to the user. Another delivery scenario can include the delivery of a particular selection of objects in a “toolkit” in order to facilitate performing a particular task. For example, if a user needs to change the oil in a motor vehicle, a set of objects that could be needed for performing an oil change can be delivered. In one such example, a delivery person can deliver the set of objects, and the user can pick and choose what is needed. Yet another delivery scenario can include the delivery of a pre-packaged set of objects for a particular event, such as a picnic or a visit to the beach. Yet another delivery scenario can include the delivery of a particular object where the user does not care where the object is sourced from, as long as it is delivered on time. Yet another delivery scenario can include the delivery of an object or set of objects that the user forgot or now needs while the user is traveling. For example, if the user is attending a formal event and forgot formal clothes, the system can facilitate delivery of a set of formalwear to the user's current or future destination.

In some embodiments, the system can facilitate the delivery of medications to a particular person or a particular location. For example, the user can create limits on persons to whom medications can be delivered or locations to which medications can be delivered.

In some embodiments, the system implements a type of bartering system, where skills of various customers can be pooled in order to facilitate the delivery of expertise or services to a user.

In some embodiments, the various delivery preferences and/or delivery scenarios described herein can be defined and/or updated using a user profile. The user can also rate delivery persons, select a “preferred” delivery person, provide customer feedback, etc.

Exemplary embodiments are described below with reference to the drawings. One of ordinary skill in the art will recognize that exemplary embodiments are not limited to the illustrative embodiments, and that components of exemplary systems, devices and methods are not limited to the illustrative embodiments described below.

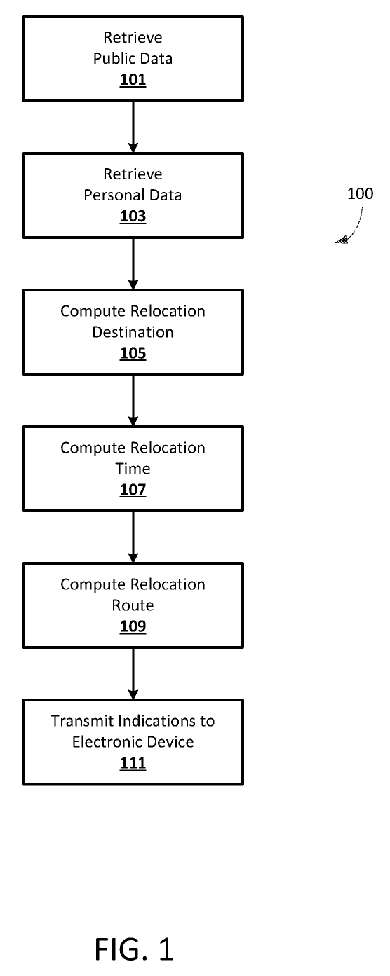

FIG. 1 is a flowchart illustrating an exemplary method 100 for generating a route for relocating objects. It will be appreciated that the method is programmatically performed by one or more computer-executable processes executing on, or in communication with one or more servers described further below. In step 101, a public data extraction module retrieves public data relating to a user's current location, a current location of an object to be delivered, and the user's future travel plans. In some embodiments, the public data is gathered by the public data extraction module from one or more social media accounts associated with the user. The public data can include, without limitation, geographic location information, or information relating to planned future activities or planned future destinations where the user will be. Information about where people are and where they are planning to be is widely available through social media accounts. This information may be public, or shared among a circle of friends. In some embodiments, this data can be fed into the system as an input to compute the optimum delivery location.

In step 103, a profile module retrieves personal data associated with the user from a database. The personal data can include user profile data provided by a user to one or more corporate or other entities including customizable relocation preferences and information relating to the user's future travel plans. In some embodiments, the user's future travel plans include information regarding the user's travel itinerary, information relating to the user's regular travel patterns, or information relating to the user's planned future activities. In one embodiment, the personal data includes account information provided by the user to an entity controlling the delivery relocation system described herein. In some embodiments, the user can have their travel plans saved within a calendar or virtual agenda, which can be populated by travel companies or linked to a user's email accounts. This data could be provided to the system as an input to compute an optimum delivery location. In other embodiments, future travel plans could be obtained from social media accounts, from repetition of existing travel, etc. This can be obtained, for example, from the customer's wearable tech, mobile phone, or connected car. The personal data can be provided to the system, in some embodiments, as part of a registration process for an application or other user account.

In step 105, a delivery analysis module computes a relocation destination for relocating the delivery of an object to be delivered to the user from a current delivery destination to a new relocation destination. The relocation destination is computed, at least in part, based on the public data and the personal data associated with the user. For example, if the user is in London instead of New York City on the day of a previously scheduled delivery, the delivery analysis module may attempt to compute a relocation destination at a site in London.

In step 107, the delivery analysis module also computes a relocation time. The relocation time corresponds to the time when the delivery will be completed at the relocation destination, and the relocation time is computed, at least in part, based on the public data and the personal data associated with the user. The relocation time may be the same time as the originally scheduled delivery time or may be adjusted to a different time.

In step 109, the delivery analysis module computes a relocation route for relocating the delivery of the object to the user at the relocation destination at the relocation time. The relocation route is based, at least in part, on the public data and the personal data associated with the user. For instance, continuing with the example above, the relocation route may be calculated to deliver a package from a England-based supply source (instead of one in New York) to the London hotel at which the user is staying.

In step 111, a notification module transmits an indication of the relocation destination and the relocation time to an electronic device associated with the user. For example, a proposed time may be sent to the user's smartphone who may accept or deny the rescheduled delivery.

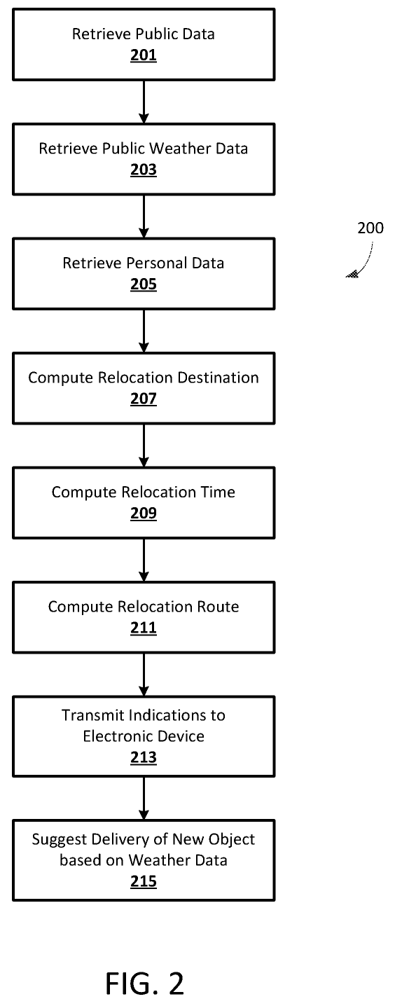

FIG. 2 is a flowchart illustrating another exemplary method 200 of generating a route for relocating delivery of objects, according to embodiments of the present disclosure. It will be appreciated that the method is programmatically performed by one or more computer-executable processes executing on, or in communication with one or more servers described further below. In step 201, a public data extraction module retrieves public data relating to a user's current location, a current location of an object to be delivered, and the user's future travel plans. In some embodiments, the public data is gathered by the public data extraction module from one or more social media accounts associated with the user. The public data can include without limitation geographic location information, or information relating to planned future activities or planned future destinations where the user will be.

In step 203, the public data extraction module retrieves public information relating to weather at a current location of the user or weather at the relocation destination.

In step 205, a profile module retrieves personal data associated with the user from a database. The personal data can include user profile data provided by a user to one or more corporate or other entities including customizable relocation preferences and information relating to the user's future travel plans. In some embodiments, the user's future travel plans include information regarding the user's travel itinerary, information relating to the user's regular travel patterns, or information relating to the user's planned future activities.

In step 207, a delivery analysis module computes a relocation destination for relocating the delivery of an object to be delivered to the user from a current delivery destination to the relocation destination. The relocation destination is computed, at least in part, based on the public data and the personal data associated with the user. The relocation destination is also computed, at least in part, based on the weather information retrieved in step 203. For example, as a result of a storm, delivery may be dynamically switched to a user's home or other location instead of a work location.

In step 209, the delivery analysis module computes a relocation time. The relocation time corresponds to the time when the delivery will be completed at the relocation destination, and the relocation time is computed, at least in part, based on the public data and the personal data associated with the user. The relocation time is also computed, at least in part, based on the weather information retrieved in step 203. For example, the weather information may cause a delay in the delivery. Alternatively, the weather information may indicate a storm is approaching and lead to the computation of an earlier delivery time in advance of the storm.

In step 211, the delivery analysis module computes a relocation route for relocating the delivery of the object to the user at the relocation destination at the relocation time. The relocation route is based, at least in part, on the public data and the personal data associated with the user. The relocation route is also computed, at least in part, based on the weather information retrieved in step 203. For example, in the case of a major snowstorm, a package may be sent via major highways versus back roads which are less likely to be plowed.

In step 213, a notification module transmits an indication of the relocation destination and the relocation time to an electronic device, such as a smartphone, associated with the user.

In step 215, the system suggests delivery of a new object to the user and transmits the object suggestion to the electronic device. The delivery analysis module and the notification module use the information relating to weather to suggest delivery of the new object to the user. For example, if an unexpected change in weather occurs, or if the user forgets to bring a weather related object such as an umbrella, the system can suggest delivery of the necessary object or objects. In some embodiments, the user can approve the delivery of the suggested object using the electronic device.

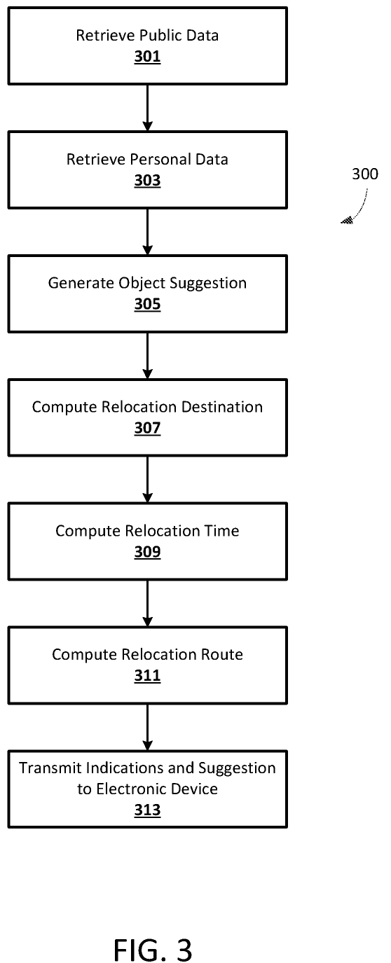

FIG. 3 is a flowchart illustrating another exemplary method 300 of generating a route for relocating delivery of objects, according to embodiments of the present disclosure. It will be appreciated that the method is programmatically performed by one or more computer-executable processes executing on, or in communication with one or more servers described further below. In step 301, a public data extraction module retrieves public data relating to a user's current location, a current location of an object to be delivered, and the user's future travel plans. In some embodiments, the public data is gathered by the public data extraction module from one or more social media accounts associated with the user. The public data can include, without limitation, geographic location information or information relating to planned future activities or planned future destinations where the user will be.

In step 303, a profile module retrieves personal data associated with the user from a database. The personal data can include user profile data provided by a user to one or more corporate or other entities including customizable relocation preferences and information relating to the user's future travel plans. In some embodiments, the user's future travel plans include information regarding the user's travel itinerary, information relating to the user's regular travel patterns, or information relating to the user's planned future activities.

In step 305, a notification module generates a suggestion of a suggested object to be delivered. The suggestion is based, at least in part, on the personal data associated with the user. As discussed above, various delivery scenario and delivery preferences can be customized by the user. These delivery preferences and delivery scenarios can facilitate in generating the suggestion. For example, if the user has changed travel plans and is now planning to attend a formal event, but does not have formalwear available, the suggestion can include a suggestion to have a set of formalwear delivered to a particular destination at a particular time.

In step 307, a delivery analysis module computes a relocation destination for relocating the delivery of an object to be delivered to the user from a current delivery destination to the relocation destination. The relocation destination is computed, at least in part, based on the public data and the personal data associated with the user.

In step 309, the delivery analysis module computes a relocation time. The relocation time corresponds to the time when the delivery will be completed at the relocation destination, and the relocation time is computed, at least in part, based on the public data and the personal data associated with the user.

In step 311, the delivery analysis module computes a relocation route for relocating the delivery of the object to the user at the relocation destination at the relocation time. The relocation route is based, at least in part, on the public data and the personal data associated with the user.

In step 313, the notification module transmits an indication of the relocation destination and the relocation time to an electronic device associated with the user. For example, a text with the data may be sent to the user's smartphone or an email may be sent to a user's email address. The notification module also transmits the suggestion generated in step 305. In some embodiments, the notification module can also transmit to the electronic device contact information for requesting goods or services related to one or more of the objects being relocated for delivery. For example, if the user has requested delivery of an object that requires professional service or assembly, the notification module can transmit contact information relating to professionals licensed to perform the required service or assembly. In other embodiments, the notification module is also configured to transmit a status update to the electronic device to update the user on a real time status of the object during the relocated delivery.

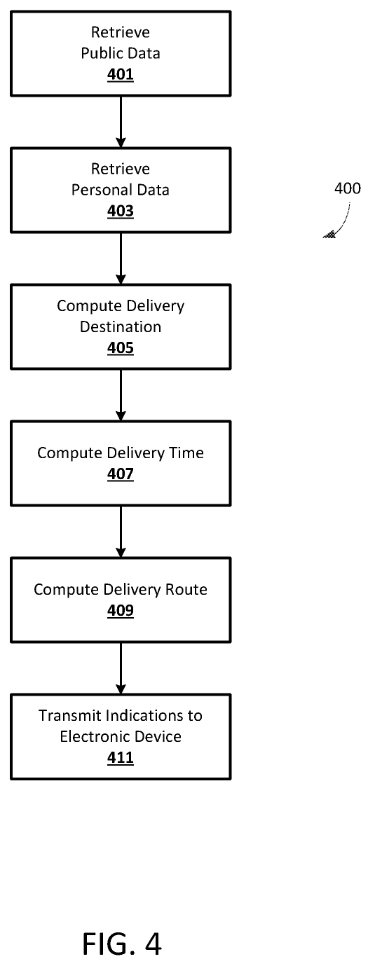

FIG. 4 is a flowchart illustrating an exemplary method 400 of initially generating a route for delivering objects, according to embodiments of the present disclosure. It will be appreciated that the method is programmatically performed by one or more computer-executable processes executing on, or in communication with one or more servers described further below. In step 401, a public data extraction module retrieves public data relating to a user's current location, a current location of an object to be delivered, and the user's future travel plans. In some embodiments, the public data is gathered by the public data extraction module from one or more social media accounts associated with the user. The public data can include without limitation geographic location information, or information relating to planned future activities or planned future destinations where the user will be.

In step 403, a profile module retrieves personal data associated with the user from a database. The personal data can include user profile data provided by a user to one or more corporate or other entities including customizable relocation preferences and information relating to the user's future travel plans. In some embodiments, the user's future travel plans include information regarding the user's travel itinerary, information relating to the user's regular travel patterns, or information relating to the user's planned future activities.

In step 405, a delivery analysis module computes a delivery destination for delivery of an object to be delivered to the user. The delivery destination is computed, at least in part, based on the public data and the personal data associated with the user.

In step 407, the delivery analysis module computes a delivery time. The delivery time corresponds to the time when the delivery will be completed at the delivery destination, and the delivery time is computed, at least in part, based on the public data and the personal data associated with the user.

In step 409, the delivery analysis module computes a delivery route for delivering the object to the user at the delivery destination at the delivery time. The delivery route is based, at least in part, on the public data and the personal data associated with the user.

In step 411, a notification module transmits an indication of the delivery destination and the delivery time to an electronic device associated with the user, such as the user's smartphone.

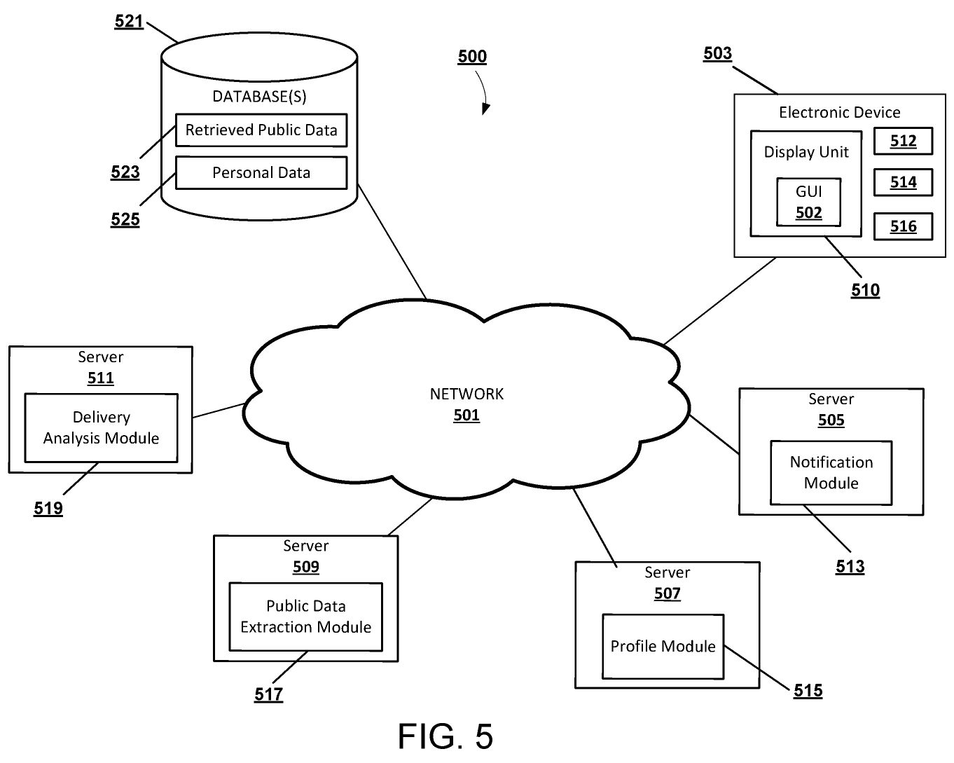

FIG. 5 illustrates a network diagram depicting a system 500 suitable for a distributed implementation of exemplary embodiments. The system 500 can include a network 501, electronic device 503, servers 505, 507, 509, and 511, and a database 521. As will be appreciated, various distributed or centralized configurations may be implemented. In exemplary embodiments, server 505 can store a notification module 513, server 507 can store a profile module 515, server 509 can store a public data extraction module 517, and server 511 can store a delivery analysis module 519, each of which can implement one or more of the processes described herein with reference to FIGS. 1-4, or portions thereof. It will be appreciated that the module functionality may be implemented as a greater or lesser number of modules than illustrated and that the same server could also host multiple modules. The database 521 can store the retrieved public data 523 and personal data 525, in exemplary embodiments.

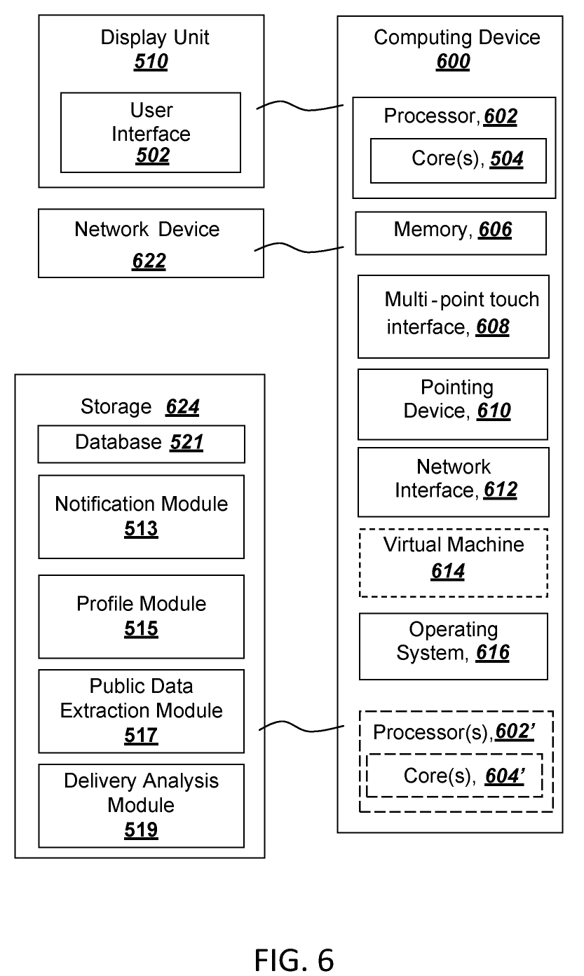

In exemplary embodiments, the electronic device 503 may include a display unit 510, which can display a GUI 502 to a user of the mobile electronic device. The mobile electronic device can also include a memory 512, processor 514, and a wireless interface 516. In some embodiments, the electronic device 503 may include, but is not limited to, work stations, computers, general purpose computers, Internet appliances, hand-held devices, wireless devices, portable devices, wearable computers, cellular or mobile phones, portable digital assistants (PDAs), smart phones, tablets, ultrabooks, netbooks, laptops, desktops, multi-processor systems, microprocessor-based or programmable consumer electronics, game consoles, set-top boxes, network PCs, mini-computers, smartphones, tablets, netbooks, and the like. The electronic device 503 may include some or all components described in relation to computing device 600 shown in FIG. 6.

The electronic device 503 may connect to a network 501 via a wired or wireless connection. The electronic device 503 may include one or more applications such as, but not limited to, a web browser, a sales transaction application, an object reader application, and the like.

In exemplary embodiments, the electronic device 503, servers 505, 507, 509, and 511, and database 521 may be in communication with each other via a communication network 501. The communication network 501 may include, but is not limited to, the Internet, an intranet, a LAN (Local Area Network), a WAN (Wide Area Network), a MAN (Metropolitan Area Network), a wireless network, an optical network, and the like. In one embodiment, the electronic device 503 and servers 505, 507, 509, and 511 can transmit instructions to each other over the communication network 501. In exemplary embodiments, the retrieved public data 523 and personal data 525 can be stored at database 521 and received at the electronic device 503 or servers 505, 507, 509, and 511 in response to a service performed by a database retrieval application.

FIG. 6 is a block diagram of an exemplary computing device 600 that can be used in the performance of any of the example methods according to the principles described herein. The computing device 600 includes one or more non-transitory computer-readable media for storing one or more computer-executable instructions (such as but not limited to software or firmware) for implementing any example method according to the principles described herein. The non-transitory computer-readable media can include, but are not limited to, one or more types of hardware memory, non-transitory tangible media (for example, one or more magnetic storage disks, one or more optical disks, one or more USB flashdrives), and the like.

For example, memory 606 included in the computing device 600 can store computer-readable and computer-executable instructions or software for implementing exemplary embodiments and programmed to perform processes described above in reference to FIGS. 1-4. The computing device 600 also includes processor 602 and associated core 604, and optionally, one or more additional processor(s) 602′ and associated core(s) 604′ (for example, in the case of computer systems having multiple processors/cores), for executing computer-readable and computer-executable instructions or software stored in the memory 606 and other programs for controlling system hardware. Processor 602 and processor(s) 602′ can each be a single core processor or multiple core (604 and 604′) processor.

Virtualization can be employed in the computing device 600 so that infrastructure and resources in the computing device can be shared dynamically. A virtual machine 614 can be provided to handle a process running on multiple processors so that the process appears to be using only one computing resource rather than multiple computing resources. Multiple virtual machines can also be used with one processor.

Memory 606 can be non-transitory computer-readable media including a computer system memory or random access memory, such as DRAM, SRAM, EDO RAM, and the like. Memory 606 can include other types of memory as well, or combinations thereof.

A user can interact with the computing device 600 through a display unit 510, such as a touch screen display or computer monitor, which can display one or more user interfaces 502 that can be provided in accordance with exemplary embodiments. The computing device 600 can also include other I/O devices for receiving input from a user, for example, a keyboard or any suitable multi-point touch interface 608, a pointing device 610 (e.g., a pen, stylus, mouse, or trackpad). The multi-point touch interface 608 and the pointing device 610 can be coupled to the display unit 510. The computing device 600 can include other suitable conventional I/O peripherals.

The computing device 600 can also include one or more storage devices 624, such as a hard-drive, CD-ROM, or other non-transitory computer readable media, for storing data and computer-readable instructions and/or software, such as a notification module 513, profile module 515, public data extraction module 517, or delivery analysis module 519 that can implement exemplary embodiments of the methods and systems as taught herein, or portions thereof. Exemplary storage device 624 can also store one or more databases 521 for storing any suitable information required to implement exemplary embodiments. The databases can be updated by a user or automatically at any suitable time to add, delete, or update one or more items in the databases. Exemplary storage device 624 can store one or more databases 521 for storing the retrieved public data 523, personal data 525, and any other data/information used to implement exemplary embodiments of the systems and methods described herein.

The computing device 600 can include a network interface 612 configured to interface via one or more network devices 622 with one or more networks, for example, Local Area Network (LAN), Wide Area Network (WAN) or the Internet through a variety of connections including, but not limited to, standard telephone lines, LAN or WAN links (for example, 802.11, T1, T3, 56kb, X.25), broadband connections (for example, ISDN, Frame Relay, ATM), wireless connections, controller area network (CAN), or some combination of any or all of the above. The network interface 612 can include a built-in network adapter, network interface card, PCMCIA network card, card bus network adapter, wireless network adapter, USB network adapter, modem or any other device suitable for interfacing the computing device 600 to any type of network capable of communication and performing the operations described herein. Moreover, the computing device 600 can be any computer system, such as a workstation, desktop computer, server, laptop, handheld computer, tablet computer (e.g., the iPad® tablet computer), mobile computing or communication device (e.g., the iPhone® communication device), or other form of computing or telecommunications device that is capable of communication and that has sufficient processor power and memory capacity to perform the operations described herein.

The computing device 600 can run any operating system 616, such as any of the versions of the Microsoft® Windows® operating systems, the different releases of the Unix and Linux operating systems, any version of the MacOS® for Macintosh computers, any embedded operating system, any real-time operating system, any open source operating system, any proprietary operating system, any operating systems for mobile computing devices, or any other operating system capable of running on the computing device and performing the operations described herein. In exemplary embodiments, the operating system 616 can be run in native mode or emulated mode. In an exemplary embodiment, the operating system 616 can be run on one or more cloud machine instances.

In describing example embodiments, specific terminology is used for the sake of clarity. For purposes of description, each specific term is intended to at least include all technical and functional equivalents that operate in a similar manner to accomplish a similar purpose. Additionally, in some instances where a particular example embodiment includes system elements, device components or method steps, those elements, components or steps can be replaced with a single element, component or step. Likewise, a single element, component or step can be replaced with a plurality of elements, components or steps that serve the same purpose. Moreover, while example embodiments have been shown and described with references to particular embodiments thereof, those of ordinary skill in the art will understand that various substitutions and alterations in form and detail can be made therein without departing from the scope of the disclosure. Further still, other aspects, functions and advantages are also within the scope of the disclosure.

Example flowcharts are provided herein for illustrative purposes and are non-limiting examples of methods. One of ordinary skill in the art will recognize that example methods can include more or fewer steps than those illustrated in the example flowcharts, and that the steps in the example flowcharts can be performed in a different order than the order shown in the illustrative flowcharts.

What is claimed is:

1. A system for dynamically generating routes for relocating delivery of objects, the system comprising:
a database holding personal data associated with, and provided by, a user; and
a computing device equipped with a processor, the computing device in communication with the database and an electronic device associated with the user, the processor configured to execute:
a public data extraction module, the public data extraction module configured to retrieve public data relating to the user's current location, a current location of an object to be delivered, and the user's future travel plans,
a profile module, the profile module configured to retrieve personal data associated with the user from the database, the personal data including at least one of customizable relocation preferences and future travel plans of the user,
a delivery analysis module, the delivery analysis module configured to:
compute a relocation destination for relocating delivery of the object to be delivered to the user from a current delivery destination to the relocation destination, the relocation destination based at least in part on the public data and the personal data associated with the user,
compute a relocation time based at least in part on the public data and the personal data associated with the user, and
compute a relocation route for relocating the delivery of the object to the user at the relocation destination at the relocation time, the relocation route based at least in part on the public data and the personal data associated with the user, and
a notification module, the notification module configured to transmit an indication of the relocation destination and the relocation time to the electronic device associated with the user.

2. The system of claim 1, wherein the public data is gathered by the public data extraction module from one or more social media accounts associated with the user, the public data including at least one of user preferences, geographic location information, and information relating to planned future activities.

3. The system of claim 1, wherein the user's future travel plans include at least one of the user's travel itinerary, regular travel patterns, and planned future activities.

4. The system of claim 1, wherein the notification module is further configured to transmit contact information for requesting goods or services related to the object being relocated for delivery to the electronic device associated with the user.

5. The system of claim 1, wherein the notification module is further configured to generate a suggestion of a suggested object to be delivered to the user, the suggestion based at least in part on the personal data associated with the user.

6. The system of claim 1, wherein the notification module is further configured to transmit a status update to the electronic device associated with the user to update the user on a real time status of the object during the relocated delivery.

7. The system of claim 1, wherein the public data extraction module is further configured to retrieve public information relating to weather at a current location of the user or weather at the relocation destination.

8. The system of claim 7, wherein the delivery analysis module uses the information relating to weather to compute at least one of the relocation destination, relocation time and relocation route.

9. The system of claim 7, wherein the delivery analysis module and the notification module use the information relating to weather to suggest delivery of a new object to the user.

10. A method for dynamically generating routes for relocating delivery of objects, the method comprising:
retrieving public data, via a public data extraction module, relating to a user's current location, a current location of an object to be delivered, and the user's future travel plans;
retrieving personal data associated with the user from a database, via a profile module, the personal data including at least one of customizable relocation preferences and future travel plans of the user;
computing, via a delivery analysis module, a relocation destination for relocating delivery of the object to be delivered to the user from a current delivery destination to the relocation destination, the relocation destination based at least in part on the public data and the personal data associated with the user;
computing, via the delivery analysis module, a relocation time based at least in part on the public data and the personal data associated with the user;
computing, via the delivery analysis module, a relocation route for relocating the delivery of the object to the user at the relocation destination at the relocation time, the relocation route based at least in part on the public data and the personal data associated with the user; and
transmitting, via a notification module, an indication of the relocation destination and the relocation time to an electronic device associated with the user.

11. The method of claim 10, wherein the public data is gathered by the public data extraction module from one or more social media accounts associated with the user, the public data including at least one of user preferences, geographic location information, and information relating to planned future activities.

12. The method of claim 10, wherein the user's future travel plans include at least one of the user's travel itinerary, regular travel patterns, and planned future activities.

13. The method of claim 10, further comprising transmitting to the electronic device associated with the user contact information for requesting goods or services related to the object being relocated for delivery.

14. The method of claim 10, further comprising generating a suggestion of a suggested object to be delivered to the user, the suggestion based at least in part on the personal data associated with the user.

15. The method of claim 10, further comprising transmitting a status update to the electronic device associated with the user to update the user on a real time status of the object during the relocated delivery.

16. The method of claim 10, further comprising retrieving public information relating to weather at a current location of the user or weather at the relocation destination.

17. The method of claim 16, wherein the delivery analysis module uses the information relating to weather to compute at least one of the relocation destination, relocation time and relocation route.

18. The method of claim 16, wherein the delivery analysis module and the notification module use the information relating to weather to suggest delivery of a new object to the user.

19. A non-transitory machine readable medium storing instructions executable by a processing device, wherein execution of the instructions causes the processing device to dynamically generate routes for relocating delivery of objects by:
retrieving public data, via a public data extraction module, relating to a user's current location, a current location of an object to be delivered, and the user's future travel plans;
retrieving personal data associated with the user from a database, via a profile module, the personal data including at least one of customizable relocation preferences and future travel plans of the user;
computing, via a delivery analysis module, a relocation destination for relocating delivery of the object to be delivered to the user from a current delivery destination to the relocation destination, the relocation destination based at least in part on the public data and the personal data associated with the user;
computing, via the delivery analysis module, a relocation time based at least in part on the public data and the personal data associated with the user;
computing, via the delivery analysis module, a relocation route for relocating the delivery of the object to the user at the relocation destination at the relocation time, the relocation route based at least in part on the public data and the personal data associated with the user; and
transmitting, via a notification module, an indication of the relocation destination and the relocation time to an electronic device associated with the user.

20. The non-transitory machine readable medium of claim 19, wherein the public data is gathered by the public data extraction module from one or more social media accounts associated with the user, the public data including at least one of user preferences, geographic location information, and information relating to planned future activities.
